(19) United States
(12) Patent Application Publication
(10) Pub. No.: US 2010/0232155 A1
(43) Pub. Date: Sep. 16, 2010

(54) COMBINATION STRUCTURE OF LED LIGHTING DEVICE

(76) Inventor: Pei-Choa WANG, Gueishan Township (TW)

Correspondence Address: HDLS Patent & Trademark Services, P.O. BOX 220746, CHANTILLY, VA, 20153-0746, US

(21) Appl. No.: 12/402,663

(22) Filed: Mar. 12, 2009

(51) Int. Cl. F21V 1/00

(52) U.S. Cl. 362/235

(57) ABSTRACT

An LED lamp with lower manufacturing costs is disclosed. The LED lamp includes a lamp set, a plurality of light-emitting modules and a transparent cover. The lamp set having an accommodating space is a barlike body composed of a lampshell and two covers. The lampshell is constituted by two lateral lampshells and one middle lampshell connected therebetween. The lateral lampshells and the middle lampshell are connected together by a fixing structure. The two covers seal the front and rear sides of the lamp set separately. Furthermore, plural light-emitting modules are installed on the interior surface of the lampshell, and the transparent cover is fixed to cover the lamp set.

### BACKGROUND OF THE INVENTION

1. Field of the Invention

The present invention generally relates to a lighting device, and more particularly to a light emitting diode (LED) streetlamp.

2. Description of Prior Art

For a conventional mercury-vapor streetlamp, the high heat resulting from a long use always makes its service life limited. Because of its high power consuming and environmental pollution, it trends toward being replaced by a light emitting diode (LED) lighting device for advantages of high intensity, power saving and long service life, etc.

However, the heat generated from the LED will have disadvantageous influence on its service life. The LED streetlamps usually employ heat dissipating devices for rapidly dissipating the heat. The heat dissipating devices of conventional LED streetlamps are provided with a plurality of heat dissipating fins on outer surfaces of the lamp bases for enhancing the heat dissipation efficiency by large heat dissipating areas. The structure of the LED streetlamp comprises a lamp set having plural lighting units and heat dissipating fins on the outer surface of the lamp base. Both the lamp base and heat dissipating fins function as a heat dissipating device. The heat dissipating device dissipates the heat of the lighting units connected on the interior surface of the lamp base.

In above structure, the lamp base and the heat dissipating fins are made of materials with good thermo-conductivity, such as aluminum or copper. Since the outer surface area of the lamp base is large, a large number of the heat dissipating fins have to be arranged on the outer surface of the lamp set. It is disadvantageous to mass production because of high molding costs and long cycle time of manufacturing when the lamp set and the heat dissipating fins are formed as an integrated body by an aluminum-extruding process or a die casting process. In addition, the finished productions tend to be damaged because of the collision during transportation. All these factors will make the manufacturing costs rise.

### SUMMARY OF THE INVENTION

It is a primary object of the invention to provide a combination structure of the LED lighting device, which can reduce the manufacturing costs.

To achieve the object, the present invention provides a combination structure of the LED lighting device, which comprises a lamp set, a plurality of light-emitting modules and a transparent cover. The lamp set having an accommodating space is a barlike body composed of a lampshell and two covers. The lampshell is constituted by two lateral lampshells and one middle lampshell connected therebetween. The two lateral lampshells incline toward each other. The lateral lampshells and the middle lampshell are connected together by a fixing structure. The two covers seal the front and rear sides of the lamp set separately. Plural light-emitting modules are arranged on interior surface of the lampshell, and the transparent cover is fixed to cover the lamp set.

In comparison with the conventional LED lighting device, the lamp set composed of a lampshell and two covers brings lower costs of molding tools, a shortened production time and safer transportation. It can improve the yield rate of products and is helpful for mass production and assembly.

### BRIEF DESCRIPTION OF DRAWINGS

FIG. 1 is a perspective view showing combination structure of LED lighting device of the present invention;

FIG. 2 is a perspective view of lampshell of the present invention;

FIG. 3 is a sectional view showing combination of lampshell of the present invention;

FIG. 4 is a perspective view of the lamp set of the present invention;

FIG. 5 is a schematic view showing combination of the light-emitting module of the present invention;

FIG. 6 is a schematic view showing assembly of the transparent cover and the opaque cover of the present invention;

FIG. 7 is a sectional view showing one side of the assembled LED lighting device; and

FIG. 8 is a schematic view showing the operating state of the present invention.

### DETAILED DESCRIPTION OF THE INVENTION

The technical characteristics, features and advantages of the present invention will become apparent in the following detailed description of preferred embodiments with reference to the accompanied drawings, and the preferred embodiments are used for illustrating the present invention only, but not intended to limit the scope of the present invention.

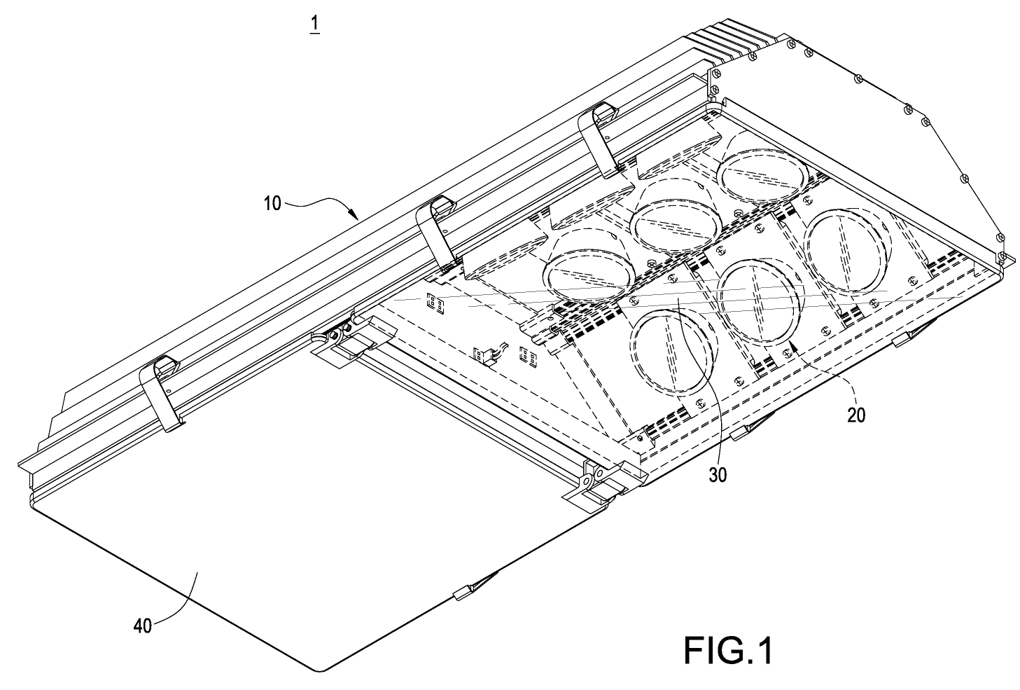

With reference to FIG. 1, the LED lamp 1 comprises a lamp set 10, a transparent cover 30 and an opaque cover 40. The lamp set 10 has a plurality of light-emitting modules 20 inside, and both the transparent cover 30 and the opaque cover 40 cover the lamp set 10.

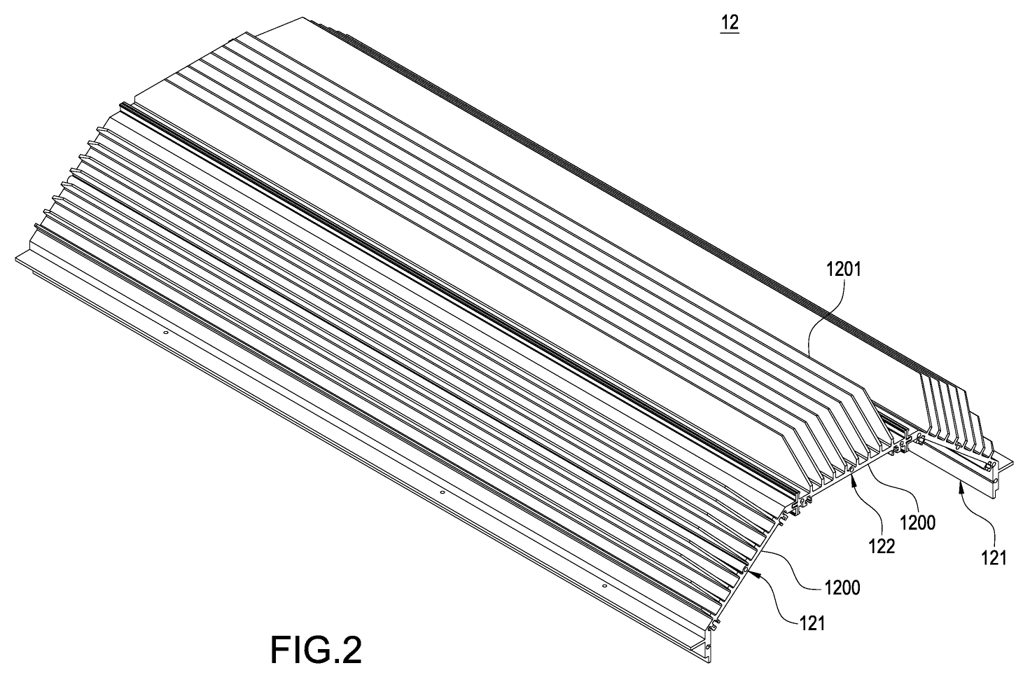

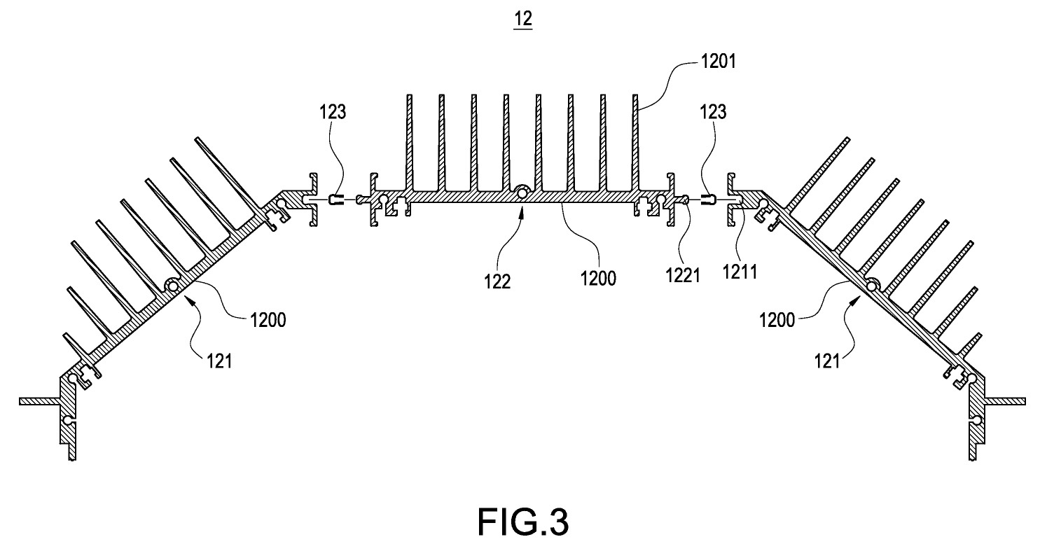

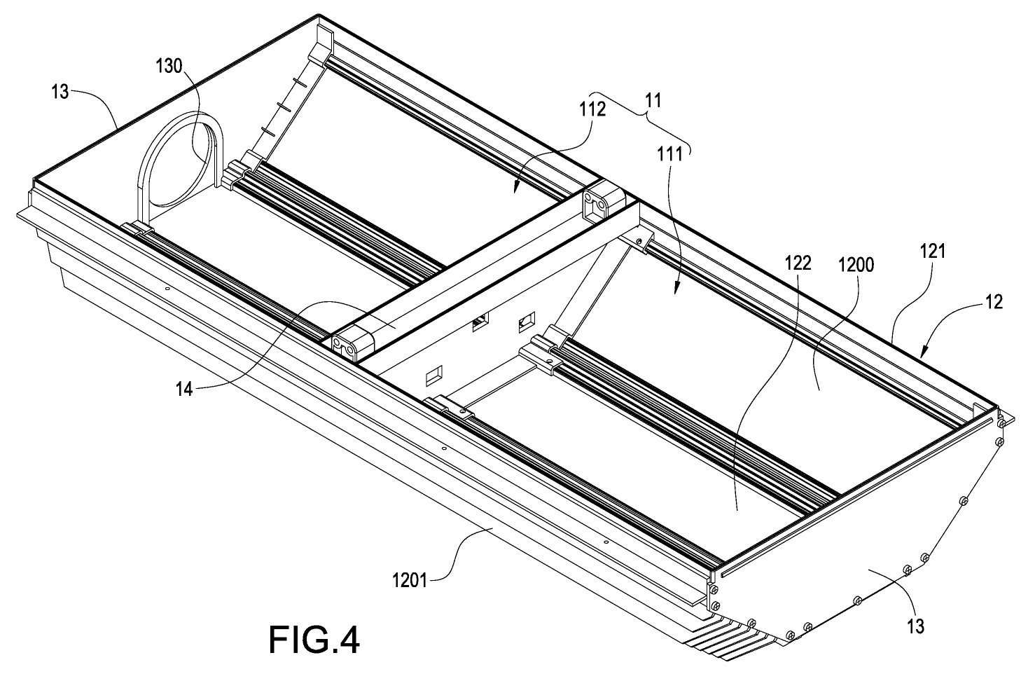

With further reference to FIGS. 2 to 4, the lamp set 10 is made of Aluminum. The lamp set 10 having an accommodating space 11 is a barlike hollow body composed of a lampshell 12 and two covers 13. The lampshell 12 is assembled by two pieces of lateral lampshell 121 and one piece of middle lampshell 122 sandwiched therebetween. The two lateral lampshells 121 incline toward each other. The lateral lampshells 121 and the middle lampshell 121 are connected together by a fixing structure. Plural heat dissipating fins 1201 are provided on outer surfaces of the lampshell 12. The fixing structure includes a slot 1211 and a tenon 1221 engaging with the slot 1211, wherein the slot 1211 is on an edge of each the lateral lampshell 121, and the tenon 1221 is on the middle lampshell 122 correspondingly. A washer 123 making a tight combination is disposed between the slot 1211 and the tenon 1221.

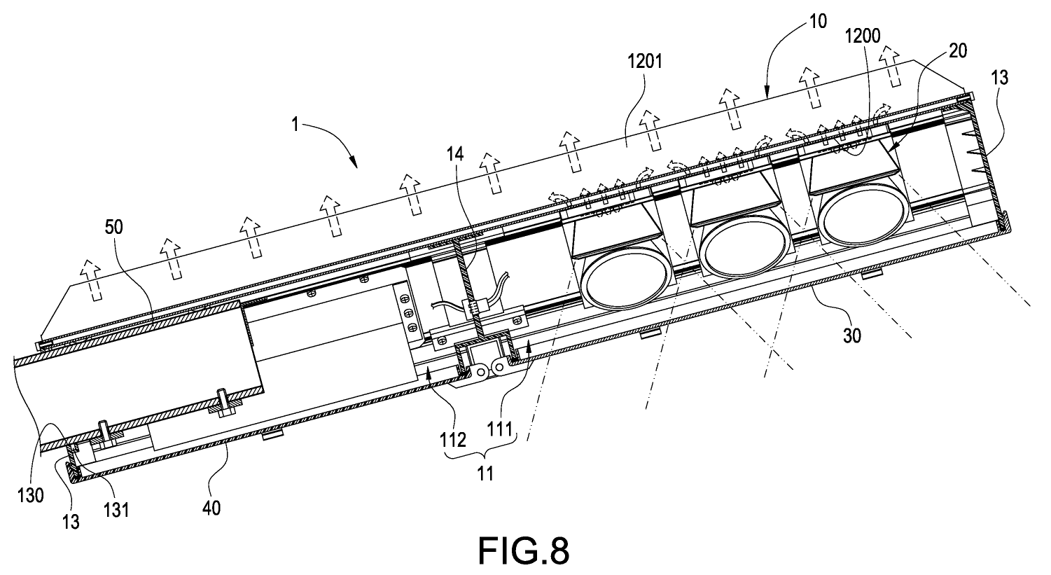

Moreover, the front and rear ends of the lampshell 12 are separately sealed by the cover 13. The two covers 13 are fastened by a plurality of screws. The rear cover 13 has an opening 130 for being inserted by a lamp pole 50 (see FIG. 8). In the accommodating space 11, a middle partition 14 is disposed to separate the accommodating space 11 into a lighting room 111 in the front and an electricity room 112 in the rear. The lighting room 111 and the electricity room 112 accommodate lighting units and electric equipments for power supplying, respectively.

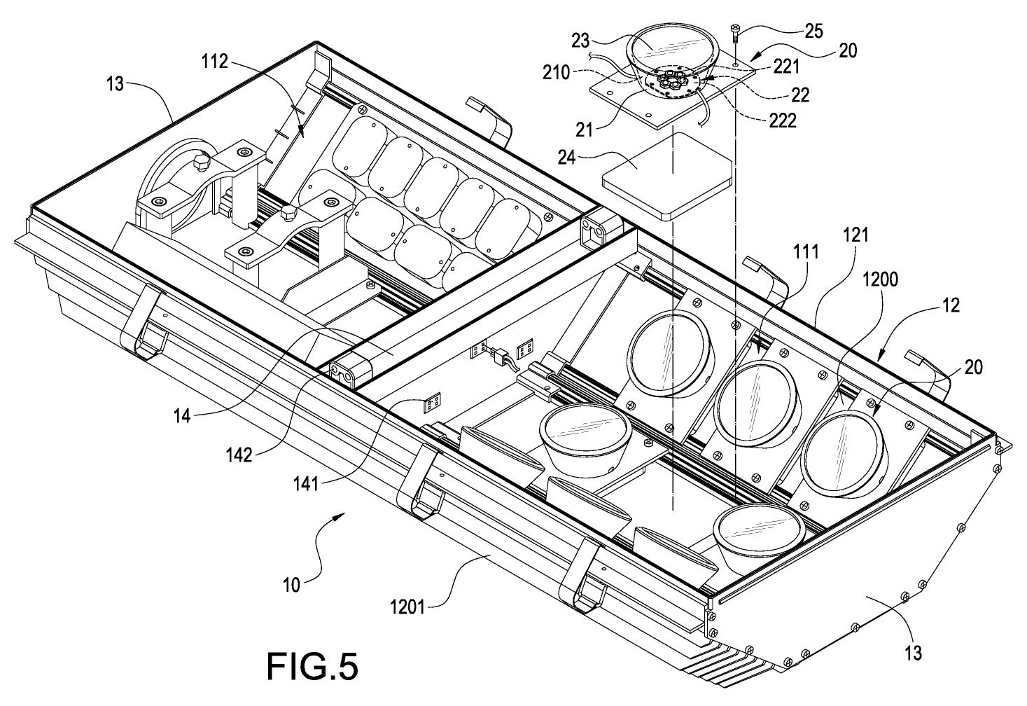

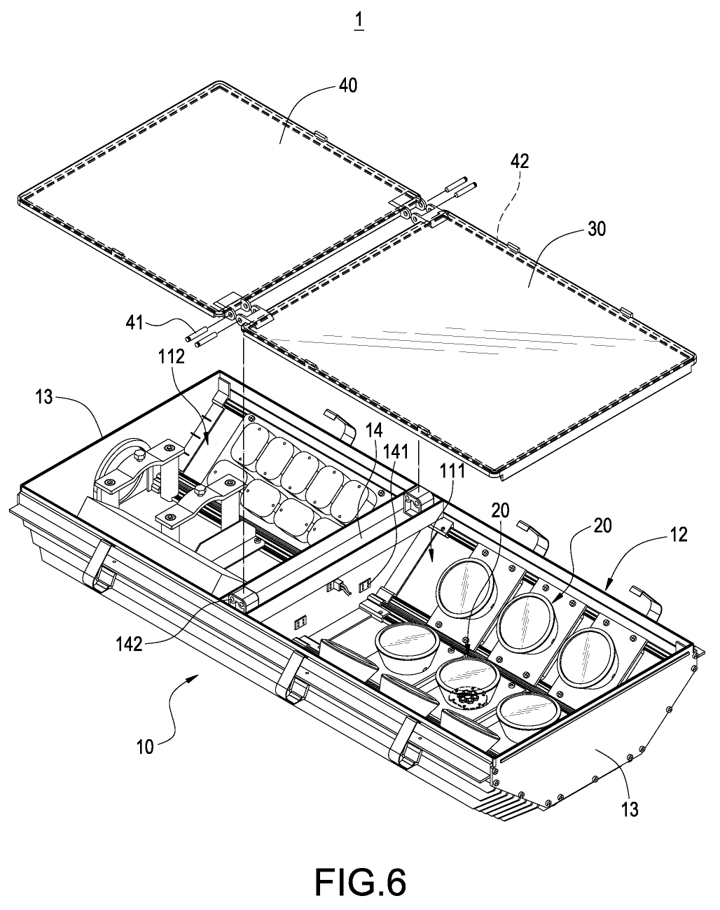

Referring to FIGS. 5 and 6, a plurality of light-emitting modules 20 accommodated in the lighting room 111 are installed on interior surface 1200 of the lampshell 12. The light-emitting module 20 comprises a cup-shaped bracket 21, a lighting unit 22 and a lens 23. One end of the cup-shaped bracket 21 is fixed on the interior surface 1200, and the other end is sealed by the lens 23. There is an accommodating trough 210 inside the cup-shaped bracket 21 for accommodating the lighting unit 22. The lighting unit 22 includes a plurality of light emitting diodes 221 disposed on a circuit board 222. The circuit board 222 connects with one side of a vapor chamber 24, and the other side is arranged on the interior surface 1200 of the lampshell 12. The vapor chamber 24 is used to uniformly conduct the heat generated from the lighting unit 22.

The middle partition 14 has a power outlet 141 for power supply. An edge of the middle partition 14 is provided with a plurality of bolt holes 142 for fixing both the transparent cover 30 and the opaque cover 40. The transparent cover 30 and the opaque cover 40 covering the lighting room 111 and the electricity room 112 respectively are fixed on the edge of the lamp set 10 by inserting fasteners 41 into the bolt holes 142. Furthermore, the opaque cover 40 is provided with a waterproof gasket 42, so is the transparent cover 30.

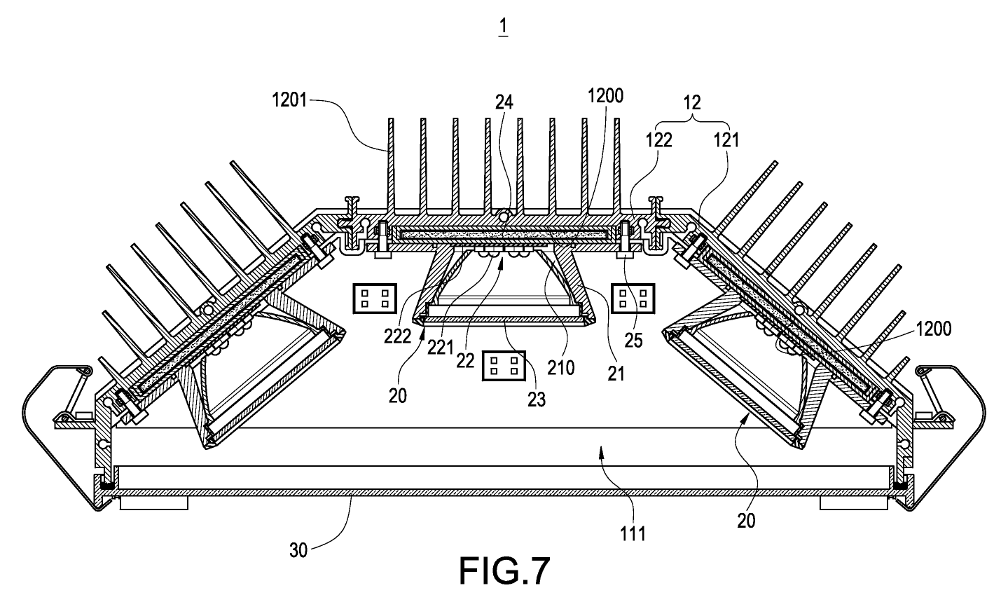

With reference to FIG. 7, the lampshell 12 is composed of two pieces of the lateral lampshells 121 and one piece of the middle lampshell 122. The tenon 1221 of the middle lampshell 122 is inserted into the slot 1211 of the lateral lampshells 121. The light-emitting module 20 accommodated in the lighting room 111 is connected to the lampshell 12 by a plurality of screws 25.

Please refer to FIG. 8, a lamp pole (not shown) can be inserted into the opening 130 on the rear cover 13. The lower edge of the opening 130 on the rear cover 13 is provided with a groove 131 for receiving the moisture and dusts. In the embodiment, nine light-emitting modules 20 installed on the interior surface 1200 of the lampshell 12 are arranged in three lines by three rows. But a skilled person in the art would know that the quantity is not limited, it can be changed in accordance with circumstances.

While the invention is described in by way of examples and in terms of a preferred embodiment, it is to be understood that the invention is not limited thereto. On the contrary, the aim is to cover all modifications, alternatives and equivalents falling within the spirit and scope of the invention as defined by the appended claims.

What is claimed is:

1. A combination structure of light-emitting diode (LED) lighting device, comprising:
a lamp set having an accommodating space, composed of a lampshell and two covers, wherein the lampshell is constituted by two pieces of lateral lampshell and one piece of middle lampshell connected therebetween, the lateral lampshells and the middle lampshell are connected by a fixing structure, and the two covers sealing the front and rear ends of the lamp separately;
a plurality of light-emitting modules installed on an interior surface of the lampshell, wherein each of the light-emitting modules comprises:
a cup-shaped bracket whose one end fixed on the interior surface of the lampshell, and an accommodating trough formed inside the cup-shaped bracket;
a lighting unit composed of a plurality of LEDs accommodated in the accommodating trough; and
a lens covering the other end of the cup-shaped bracket; and
a transparent cover covering an outer side of the lamp set.

2. The combination structure of LED lighting device of claim 1, wherein an outer surface of the lamp base is provided with a plurality of heat dissipating fins.

3. The combination structure of LED lighting device of claim 1, wherein the fixing structure includes a slot and a tenon engaging with the slot, wherein the slot is on an edge of each the lateral lampshell, and the tenon is on an edge of the middle lampshell correspondingly.

4. The combination structure of LED lighting device of claim 3, further comprising a washer disposed between the slot and the tenon.

5. The combination structure of LED lighting device of claim 1, wherein the cover has an opening for being inserted by a lamp pole on the rear end of the lamp set, and a lower edge of the opening has a groove for receiving moisture and dusts.

6. The combination structure of LED lighting device of claim 1, wherein the transparent cover is further provided with a waterproof gasket.

7. The combination structure of LED lighting device of claim 1, further comprising a middle partition in the accommodating space for separating the accommodating space into a lighting room and an electricity room.

8. The combination structure of LED lighting device of claim 7, wherein the middle partition of the lamp set is provided with a power outlet for power supply.

9. The combination structure of LED lighting device of claim 7, wherein the lighting room and the electricity room are covered by a transparent cover and an opaque cover respectively.

10. The combination structure of LED lighting device of claim 9, wherein the opaque cover is provided with a waterproof gasket.

11. The combination structure of LED lighting device of claim 1, further comprising a vapor chamber, whose one side is connected to the light-emitting module, and the other side is fixed on the interior surface of the lampshell.
